(19) United States
(12) Patent Application Publication
(10) Pub. No.: US 2013/0215055 A1
(43) Pub. Date: Aug. 22, 2013

(54) ORDER RECEPTION APPARATUS

(71) Applicant: Toshiba Tec Kabushiki Kaisha, (US)

(72) Inventors: Yumiko Okuma, Tokyo-to (JP); Maki Sato, Kanagawa-ken (JP)

(73) Assignee: TOSHIBA TEC KABUSHIKI KAISHA, Tokyo (JP)

(21) Appl. No.: 13/768,167

(22) Filed: Feb. 15, 2013

(30) Foreign Application Priority Data
Feb. 20, 2012 (JP) 2012-034372

(51) Int. Cl. G06Q 30/06

(52) U.S. Cl. CPC G06Q 30/0643
USPC 345/173

(57) ABSTRACT

An order receiving apparatus includes a change processing section which cancels the part subject to a cancel operation and the unit price of the part from information relating to the order of the article item stored in the order information storage area if the touch input section detects an action regarded as the cancel action to any one of the parts in the article decomposition image displayed on the display section, and adds a part subject to an addition operation and the unit price of the part to information relating to the order of the article item stored in the order information storage area if the touch input section detects an action regarded as the addition operation to a specified part in the article decomposition image displayed on the display section.

### CROSS-REFERENCE TO RELATED APPLICATION

This application is based upon and claims the benefit of priority from Japanese Patent Application No. 2012-034372, filed Feb. 20, 2012, the entire contents of which are incorporated herein by reference.

### FIELD

Embodiments described herein relate to an order reception apparatus.

### BACKGROUND

Conventionally, as an order reception apparatus for restaurant, an apparatus in which images of a plurality of menu articles are displayed on a display with a touch panel and when one of the images of the plurality of menu articles is directly touched, then the reception processing is performed on a menu article corresponding to the image touched as the menu item is ordered by a customer is known.

### BRIEF DESCRIPTION OF THE DRAWINGS

FIG. 1 is a block diagram illustrating an entire construction of a self-service order system according to the present embodiment;

FIG. 2 is a schematic diagram illustrating an example of data stored in a category database;

FIG. 3 is a schematic diagram illustrating an example of data stored in an article database;

FIG. 4 is a schematic diagram illustrating an example of data stored in an image database 2;

FIG. 5 is a block diagram illustrating main compositions of an electronic menu terminal;

FIG. 6 is a flow chart illustrating an example of a flow of order reception processing;

FIG. 7 is a flow chart illustrating an example of a flow of the order reception processing;

FIG. 8 is a front view illustrating a screen display example in the order reception processing;

FIG. 9 is a front view illustrating a screen display example in the order reception processing;

FIG. 10 is a front view illustrating a screen display example in the order reception processing;

FIG. 11 is a front view illustrating a screen display example in the order reception processing;

FIG. 12 is a front view illustrating a screen display example in the order reception processing;

FIG. 13 is a schematic diagram illustrating an example of an order information record;

FIG. 14 is a flow chart illustrating an example of a flow of a my favorite-order reception processing;

FIG. 15 is a front view illustrating a screen display example in the my favorite-order reception processing;

FIG. 16 is a front view illustrating a screen display example in the may favorite-order reception processing;

FIG. 17 is a front view illustrating a screen display example in the may favorite-order reception processing; and

FIG. 18 is a front view illustrating an example of a screen of an order list on which the my favorite-order reception processing is executed.

### DETAILED DESCRIPTION

In accordance with an embodiment, an order reception apparatus comprises:

a display section configured to display an image;

a touch input section configured to detect the presence of touching and the movement of a point of the touching on an image displayed on the display section as an input;

an article information file, including apart which is set as an element of an article item or a part which is set as an element capable of being added to the article item, and a unit price corresponding to the part, which is configured to store an article information relating to the order of an article item for each article item;

an article image file configured to store the image of the part which is set for each article item in the article information file;

an order reception section configured to receive the order of an article item;

an order information storage section configured to read out information according to the order of an article item order of which is received by the order reception section from the article information file and store the information in a specified order information storage area;

an article decomposition image display section configured to display on the display section an article decomposition image formed with the combination of images of the parts, set as an element of the article item order of which is received by the order reception section, which are read out from the commodity image file; and

a change processing section configured to cancel the part subject to a cancel operation and the unit price of the part from information relating to the order of the article item stored in the order information storage area if the touch input section detects an action regarded as the cancel action to any one of the parts in the article decomposition image displayed on the display section, and add a part subject to an addition operation and the unit price of the part to information relating to the order of the article item stored in the order information storage area if the touch input section detects an action regarded as the addition operation to a specified part in the article decomposition image displayed on the display section.

Hereinafter, the present embodiment will be described with reference to the accompanying drawings. In addition, the present embodiment is an example applying an electronic menu terminal forming a self-order system constructed for a restaurant such as a fast-food restaurant and the like to the order receiving reception apparatus.

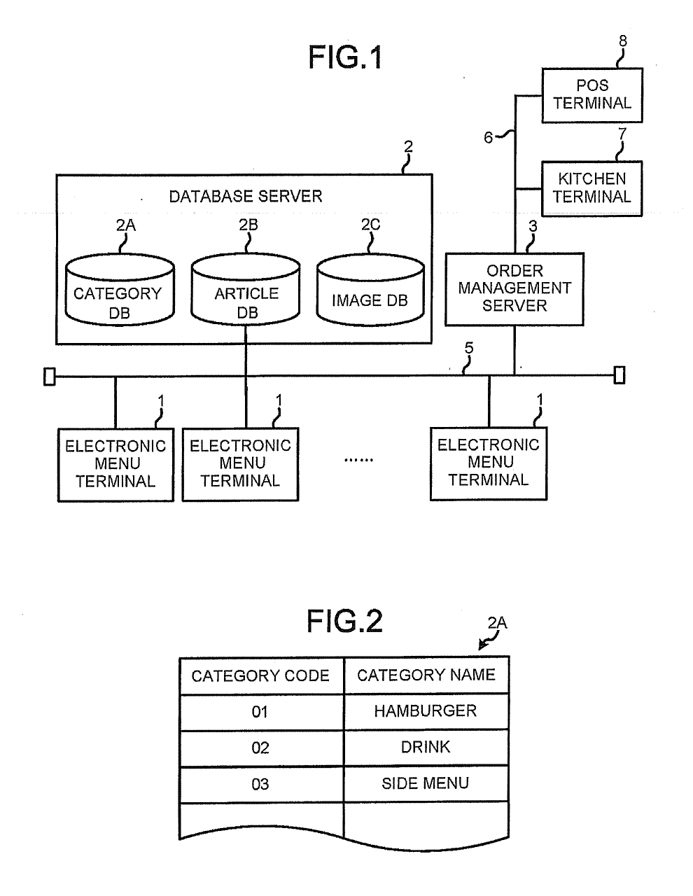

FIG. 1 is a block diagram illustrating an entire construction of the self-service order system according to the present embodiment. As shown in FIG. 1, the self-service order system comprises a plurality of electronic menu terminals 1, a database server 2 and an order management server 3. Each electronic menu terminal 1 is respectively connected with the database server 2 and the order management server 3 through a network 5 such as an LAN (Local Area Network) and the like.

The order management server 3 is a computer specialized to manage the order data of a customer and is connected with a kitchen terminal 7 and a POS (Point Of Sales) terminal 8 through a privately or exclusive line 6. The order management server 3 has a function supporting the order reception processing of an article executed by each electronic menu terminal 1 and a function carrying out registration processing on the order data of the customer received through each electronic menu terminal 1. In addition, the order management server 3 also has a function supporting a cooking instruction to a kitchen and a checkout service based on the order data on which the registration processing is carried out.

The kitchen terminal 7 generates a cooking instruction data to the kitchen based on the order data of each customer and displays them or prints them. The POS terminal 8 calculates a payment amount according to the order data of the customer requesting the checkout and processes a checkout data for the payment amount to issue a receipt. In addition, the line connecting the order management server 3 with the kitchen terminal 7 and the POS terminal 8 is not limited to the exclusive line 6, and the kitchen terminal 7 and the POS terminal 8 may be connected with the network 5 and transmission/reception of the data to or from the order management server 3 may be carried out through the network 5.

The database server 2 is a computer specialized to manage various databases such as a category database 2A, an article database 2B, an image database 2C and the like.

The category database 2A is an area storing the information relating to a category used for classifying various menu articles, and an example of the data stored in the category database 2A is shown in FIG. 2. As shown in FIG. 2, a record stored in the category database 2A includes a category code and a category name. The category name, for example, is a name denoting the category such as a hamburger, a beverage, a side menu and the like. The category code is an inherent code allocated to each category to recognize each category.

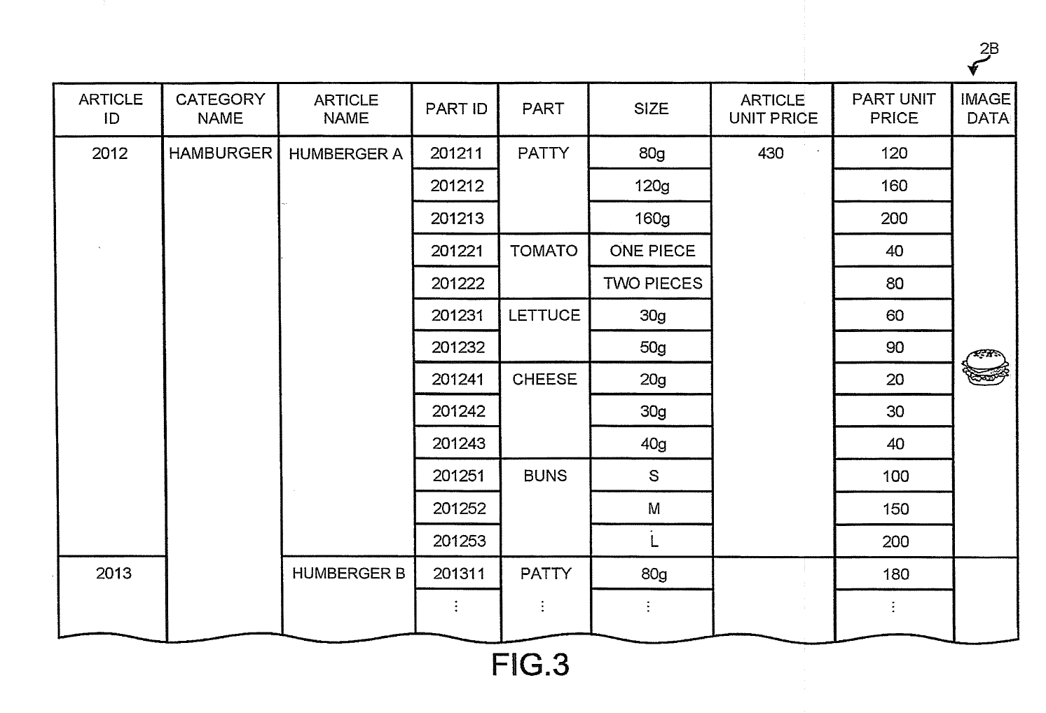

The commodity database 2B is an area storing the article information relating to the order of the article for each article item which can be ordered as an article item different from the same article by altering the kind or the weight of a food material constituting each menu article, and an example of the data stored in the article database 2B is shown in FIG. 3. As shown in FIG. 3, the record of the article database 2B includes an article ID, a category name, an article name, a part ID, a part, a size, an article unit price, a part unit price and an image data.

The article ID is the inherent code allocated to each article to recognize each menu article. The category name is the name of the category to which the menu article belongs. The article name and the article unit price are the name of the menu article and the price par one menu article.

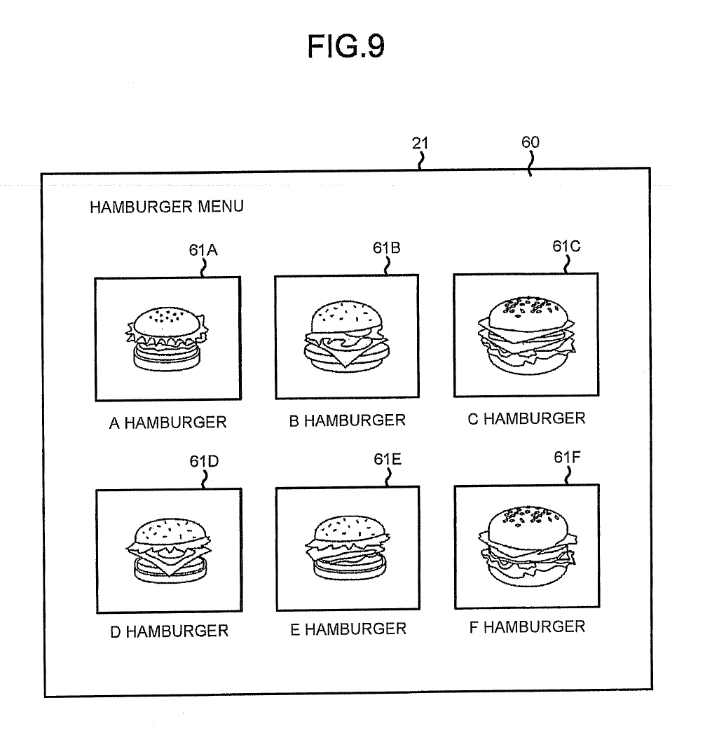

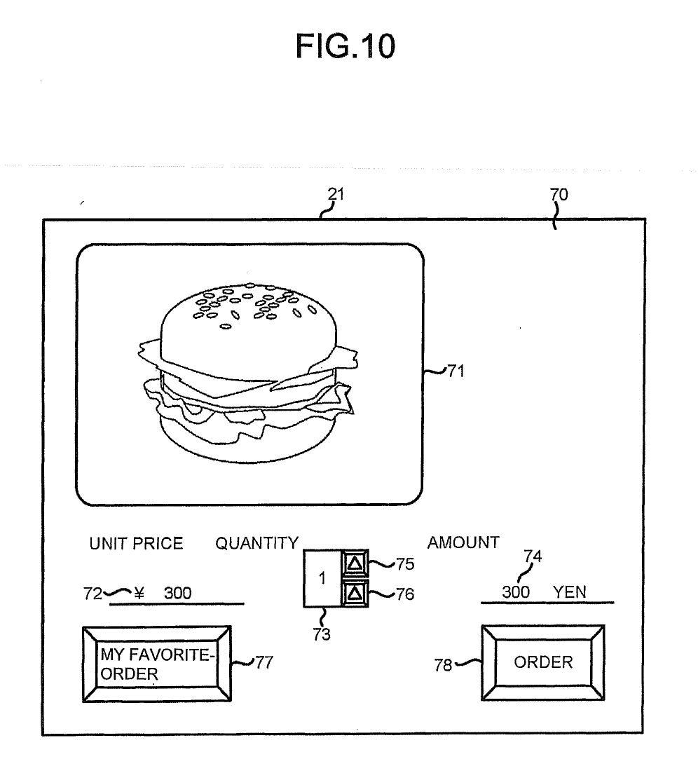

In addition, the image data stores the color image data of the article item specified by the article ID according to each article ID of menu article. The image data is used as the image data for the summary of the menu articles displayed on the summary screen 60 (referring to FIG. 9) of the menu article described later or the standard image data of the menu article displayed on the article guide screen 70 described later (referring to FIG. 10)

In addition, as shown in FIG. 3, in the article database 2B, the part ID and the part unit price are set for each weight of food material (part size).

As shown in FIG. 3, for example, the menu article “hamburger A” or “hamburger B” belonging to the category “hamburger” has a plurality of weights for each food material (part) such as patty, tomato, vegetable, cheese and the like forming the hamburger.

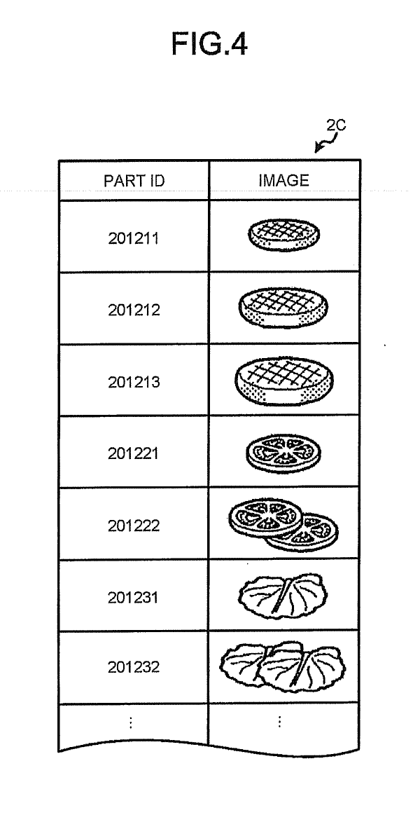

The image database 2C is an area storing the color image data of the article item for each article item, and an example of the data stored in the image database 2C is shown in FIG. 4. As shown in FIG. 4, the record of the image database 2C corresponds to the food material set in the article database 2B in FIG. 3, and the color image data of the food material specified by the part ID are stored according to each part ID of the food material.

Next, the electronic menu terminal 1 will be described. The electronic menu terminal 1 has a function as an electronic menu displaying the summary of a plurality of eat and drink menu articles provided for the customer in the restaurant and a function as an order input which transmits the menu article ordered by the customer from the menu articles to the order management server 3.

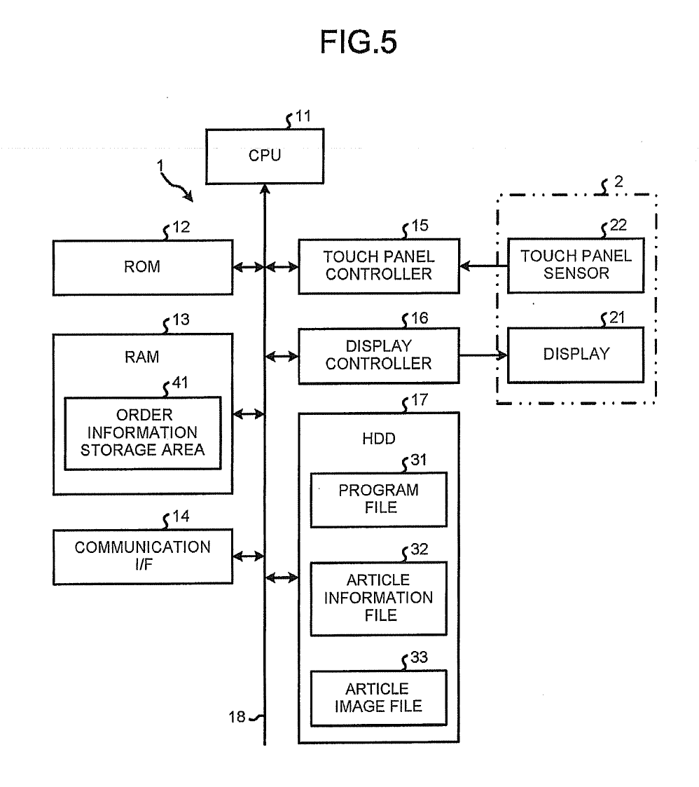

FIG. 5 is a block diagram illustrating main compositions of the electronic menu terminal 1. As shown in FIG. 5, the electronic menu terminal 1 is a computer having a display 2 with a touch panel which serves as both an input device and a display device. The electronic menu terminal 1 is equipped with a CPU (Central Processing Unit) 11 forming a control unit main body, a ROM (Read Only Memory) 12 storing fixed data such as the program and the like and a RAM (Random Access Memory) 13 in which various storage areas used for temporarily storing variable data are formed. The electronic menu terminal 1 is also equipped with a communication interface 14, a touch panel controller 15, a display controller 16, and an HDD (Hard Disk Drive) 17 as an auxiliary storage device. Moreover, the CPU 11, the ROM 12, the RAM 13, the communication interface 14, the touch panel controller 15, the display controller 16 and the HDD 17 are connected through a bus line such as an address bus, a data bus and the like. The electronic menu terminal 1 stores a terminal number forming an ID used for respectively recognizing each electronic menu terminal 1 in the RAM 13, for example.

The communication interface 14 carries out transmission and reception of the data between the electronic menu terminal 1 and the order management server 3 through a wired or wireless communication line.

The display controller 16 controls the screen display on a display unit 21 of the display 2 with the touch panel. The display unit 21 functions as a display section which can display a color image.

The touch panel controller 15 controls a touch panel sensor 22 of the display 2 with the touch panel and detects the two-dimensional coordinate of a position subjected to a touch operation. The touch panel sensor 22 is overlapped on the display 21 and functions as a contact input unit which detects presence/absence of the contact and motion of the contact point as an input action.

The HDD 17 stores a program file 31, the article information file 32 and the article image file 33 as a data file according to the present invention. The program file 31 is an area for storing an order reception program described later.

The article information file 32 is an area for storing copy of the information stored in the article database 2B of the database server 2. The article image file 33 is an area for storing copy of the information stored in the image database 2C of the database server 2.

In the electronic menu terminal 1, the order information storage area 41 which is used for temporarily storing the order information record described later on the RAM 13.

Next, the order reception processing executed by the CPU 11 of the electronic menu terminal 1 according to the order reception program will be described.

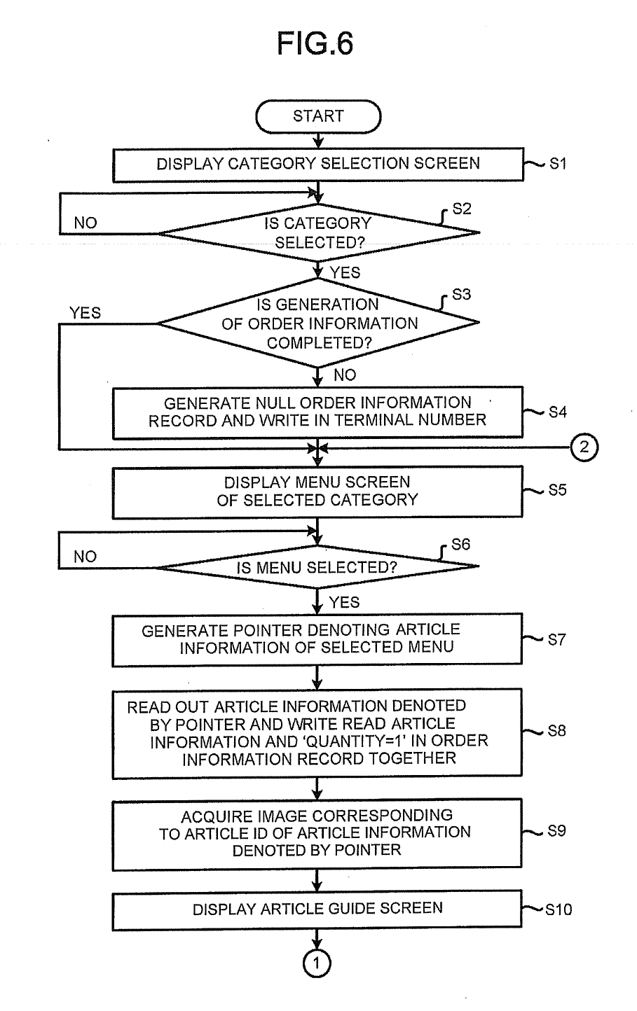

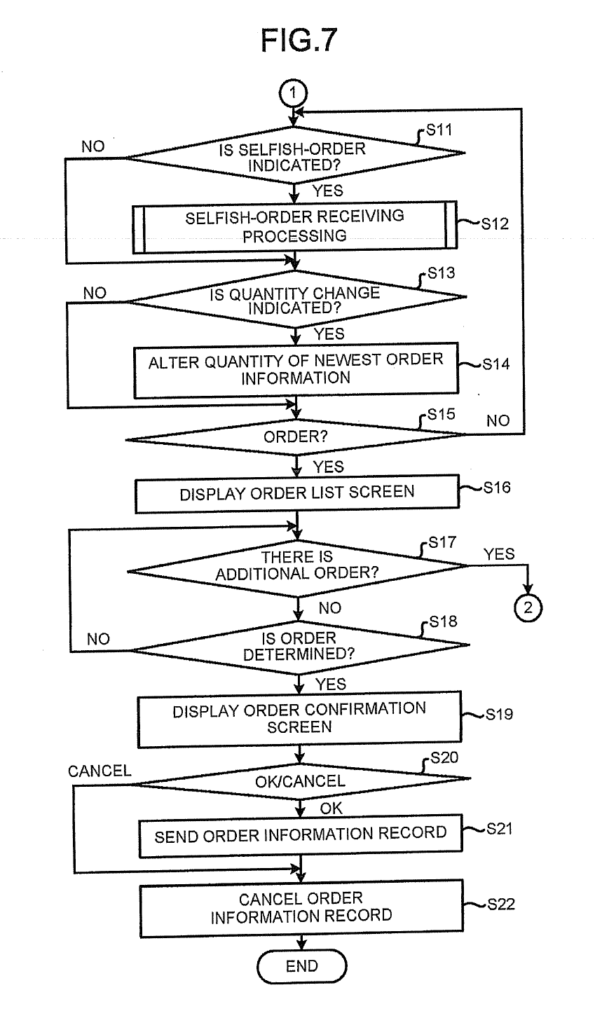

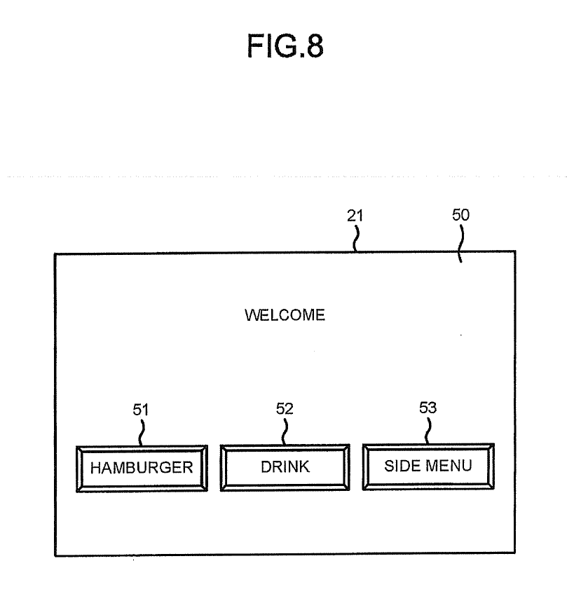

FIG. 6 and FIG. 7 are flow charts illustrating examples of the flow of the order reception processing, and FIG. 8 to FIG. 12 are examples of the screen display of the display unit 21 of the electronic menu terminal 1 in the order reception processing. An example of the order reception processing will be described based on the flow charts in FIG. 6 and FIG. 7 and the examples of the screen display in FIG. 8 to FIG. 12.

As shown in FIG. 6, the CPU 11 of the electronic menu terminal 1 first displays a category selection screen 50 on the display unit 21 (ACT S1).

An example of the category selection screen 50 is shown in FIG. 8. As shown in FIG. 8, category selection buttons 51, 52 and 53 for classifying the menu articles are displayed on the category selection screen 50.

The CPU 11 which displays the category selection screen 50 on the display unit 21 waits for the selection of any one of the categories (ACT S2). If operation of anyone of the category selection buttons 51, 52 and 53 is detected with a signal from the touch panel sensor 22, the CPU 11 judges that the category allocated to the buttons 51, 52 or 53 to which the touch operation is executed is selected (Yes in ACT S2). When the category is selected, the CPU 11 judges whether or not the generation of the order information record is completed.

If the order information record is not stored in the order information storage area 41 of the RAM 13, the CPU 11 determines that the order information record is not generated (No in ACT S3). In case that the order information record is not generated, the CPU 11 generates a null order information record and stores the null order information record in the order information storage area 41. Afterwards, the terminal number stored in the RAM 13 is written in the null order information record (ACT S4).

If the order information record is stored in the order information storage area 41, the CPU 11 determines that the generation of the order information record is completed (Yes in ACT S3). Incase that the generation of the order information record is completed, the CPU 11 omits the processing in ACT S4.

After the generation of the order information record is completed in ACT S3 or a table number is written in the null order information record in ACT S4, the CPU 11 generates the summary screen (hereinafter, called as menu screen) 60 of the menu article belonging to the selected category based on the image data of the article information file 32, and displays it on the display unit 21 (ACT S5).

An example of the menu screen 60 is shown in FIG. 9. In the example shown in FIG. 9, the menu screen 60 is shown when the category “hamburger” is selected. As shown in FIG. 9, a plurality of menu buttons 61 (61A-61F) which are respectively allocated to the menu articles belonging to the category “hamburger” are displayed on the menu screen 60.

The commodity names of the menu articles respectively allocated to the buttons are correspondingly set for each menu button 61. Moreover, the color image of the menu article allocated to the button is displayed in the button frame thereof. The article name is displayed based on the article name data stored in the article information file 32 corresponding to the article ID of the menu article. The image is displayed based on the image data stored in the article information file 32 corresponding to the same article ID.

The CPU 11 which displays the menu screen 60 on the display unit 50 waits for selection of any one of the menu articles (ACT S6).

If the touch operation to one of the menu buttons 61 is detected with the signal from the touch panel sensor 22, it is determined that the order of the menu article allocated to the menu button 61 is selected (Yes in ACT S6), and therefore, the CPU 11 processes to the processing in ACT S7.

The CPU 11 forms the order reception element for receiving the order of the menu article (article item) by executing all the processing in ACT S1 to ACT S6 in FIG. 6. In addition, the order reception element is not limited to the above composition. For example, the order reception element may be also formed such that a scanner is connected to the electronic menu terminal 1 and the order of the menu article corresponding to a code is received by scanning the code (barcode, two-dimensional data code and the like) printed on the menu.

Next, the CPU 11 generates an pointer indicating the article information of the selected menu article (ACT S7), reads out the article information indicated by the pointer from the article information file 32 and writes the article ID, the article name, the part ID for each food material, the part and the part size, and the sum of the unit price of each food material in the article information and an initial quantity “1” in the order information record as a new order information (ACT S8: the order information storage element)

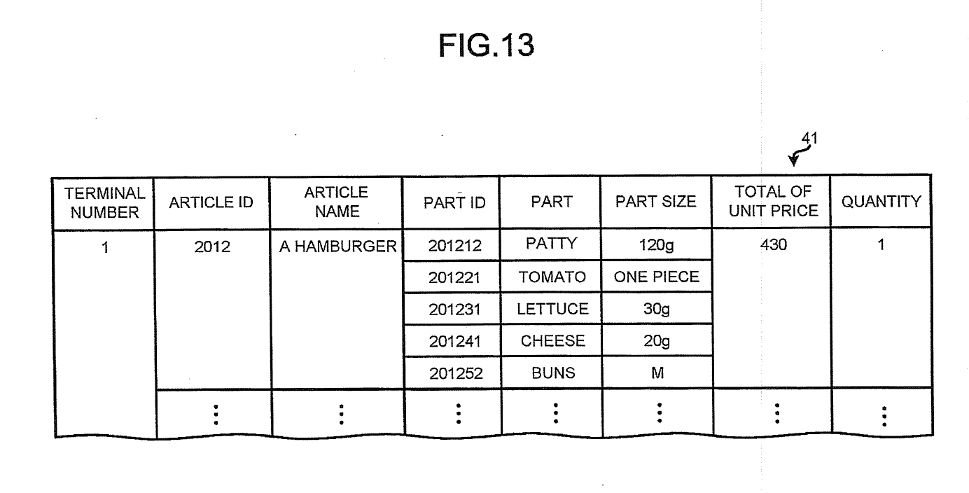

An example of the order information record is shown in FIG. 13. As shown in FIG. 13, the order information record includes a terminal number, an article ID, an article name, a part ID for each food material, a part, a part size, the sum of the unit price of each food material and the data item of the quantity. In addition, at the moment, the sum of the unit price of each food material is equal to the article unit price.

In addition, the CPU 11 retrieves the commodity information file 32, using the article ID in the article information indicated by the pointer and reads out the image data stored corresponding to the article ID (ACT S9). Afterwards, the article guide screen 70 is generated based on the image of the read-out image data and the article information written in the order information record as a new order information, and the article guide screen 70 is displayed on the display unit 21 (ACT S9: a commodity image display element)

An example of the article guide screen 70 is shown in FIG. 10. The screen 70 is displayed when the menu button 61F of the menu article “hamburger F” is touched in the menu screen 60 in FIG. 9. As shown in FIG. 10, an article image display area 71 is formed on the article guide screen 70. Moreover, the color image corresponding to the article item of the menu article “hamburger F” is displayed in the area 71. In addition, the unit price 72 and the quantity 73 in the article information written in the order information record in ACT S8 and a subtotal amount 74 which is the sum of an amount calculated by multiplying the unit price of the order information record by the quantity are also displayed in the area 71. Furthermore, an order button 78 and a my favorite-order button 77 are displayed as function buttons, and an up-button 75 and a down-button 76 are displayed as buttons for instructing the increment and the decrement of the quantity.

The CPU 11 which displays the article guide screen 70 on the display unit 50 determines whether or not a my favorite-order is instructed or requested (ACT S11), as shown in the flow chart in FIG. 7. If the touch operation to the my favorite-order button 77 on the article guide screen 70 is detected, the CPU 11 judges that the my favorite-order is instructed (Yes in ACT S11) and executes my favorite-order reception processing (ACT S12: the change processing element). Later, the my favorite-order reception processing will be described in detail.

In case that the my favorite-order reception processing is ended or the my favorite-order is not instructed (No in ACT S11), the CPU 11 judges whether or not the change of the quantity is instructed (ACT S13). When the touch operation to the up-button 75 or the down-button 76 on the article guide screen 70 is detected, the CPU 11 judges that the change of the quantity is instructed (Yes in ACT S13). Then, if the touch operation to the up-button 75 is detected, the quantity of the newest order information is increased by the number of the touch operations, or if the touch operation to the down-button 76 is detected, the quantity of the newest order information is decreased by the number of the touch operations (ACT S14). Besides, the minimum of the quantity is 1.

If the quantity change processing is ended or the change of the quantity is not instructed (No in ACT S13), the CPU 11 waits for the input of the order (ACT S15)

If the touch operation to the order button 78 is detected with a signal from the touch panel sensor 22, the order is instructed (Yes in ACT S15), and therefore, the CPU 11 generates an order list screen 80 based on the data of the order information record and displays it on the display unit 21 (ACT S16).

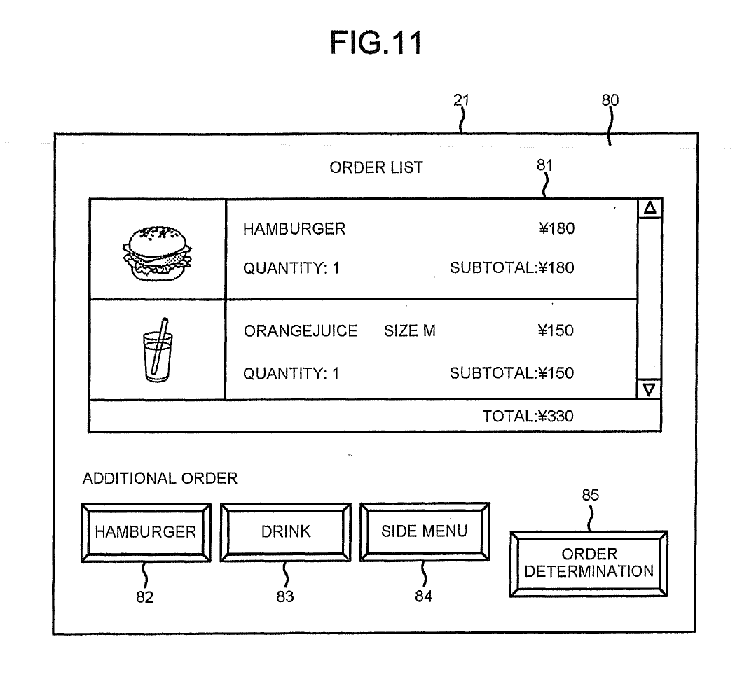

An example of the order list screen 80 is shown in FIG. 11. As shown in FIG. 11, an order list 81 indicating the content of the order information record, various category buttons 82, 83 and 84 and an order determination button 85 are displayed on the order list screen 80.

The CPU 11 which displays the order list screen 80 on the display unit 21 is in standby state until an additional order is instructed (ACT S17) or the order determination is input (ACT S18). If the touch operation to any one of the category buttons 82, 83 and 84 on the order list screen 80 is detected with the signal from the touch panel sensor 22, since the additional order is instructed (Yes in ACT S17), and therefore, the CPU 11 returns to ACT 55 and displays the menu screen 60 of the selected category on the display unit 21.

On the other hand, if the touch operation to the order determination button 85 is detected, the order determination is instructed (Yes in ACT S18), and therefore, the CPU 11 displays an order confirmation screen 90 (ACT S19).

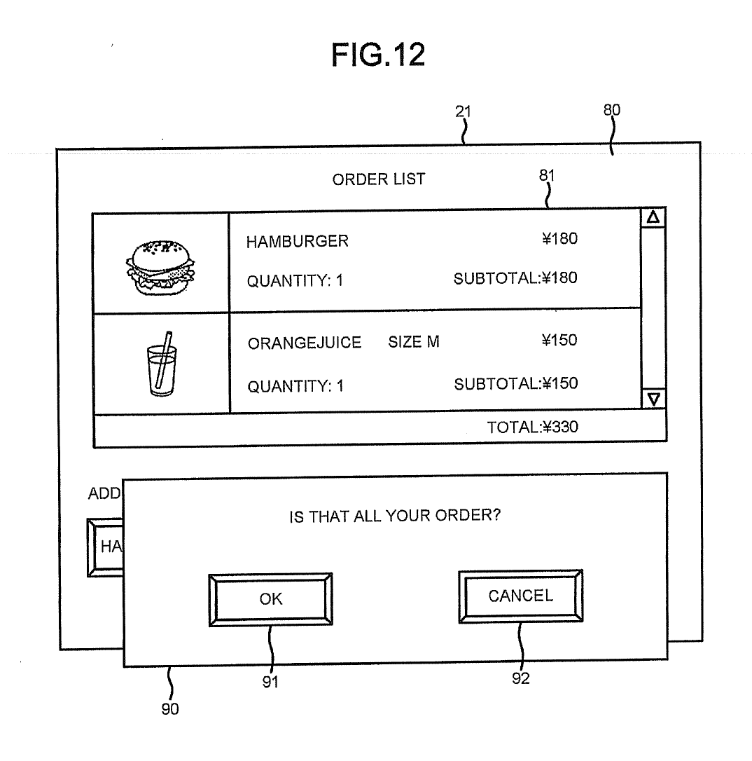

An example of the order confirmation screen 90 is shown in FIG. 12. As shown in FIG. 12, the order confirmation screen 90 is overlapped on the order list screen 80, and an OK button 91 and a cancel button 92 are displayed on the order confirmation screen 90 together with a message for confirmation.

The CPU 11 which displays the order confirmation screen 90 on the display unit 21 waits for input by one of the OK button 91 and the cancel button 92 in ACT S20. When the touch operation to the OK button 91 is detected with the signal from the touch panel sensor 22, the CPU 11 sends the order information record stored in the order information storage area 41 in ACT S21 to the order management server 3 through the communication interface 14. Subsequently, the current order information record sent to the order management server 3 is cancelled from the order information storage area 41 in ACT S22, and the order reception processing for one table is ended.

On the other hand, if the touch operation to the cancel button 92 is detected with the signal from the touch panel sensor 22, the processing in ACT S21 is omitted, and the processing in ACT S22 is executed. That is, the current order information record in the order information storage area 41 is canceled without transmitting it and the processing is ended.

Next, the my favorite-order reception processing (the change processing element) in ACT S12 shown in the flow chart in FIG. 7 will be described.

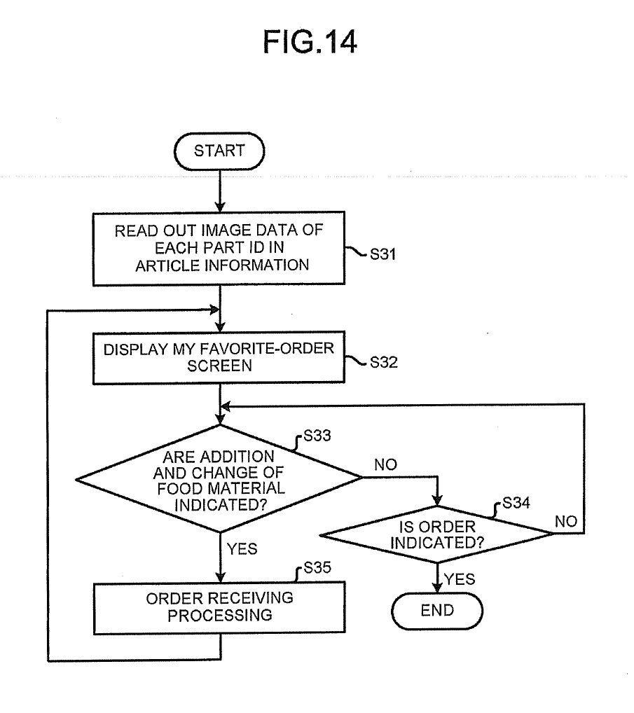

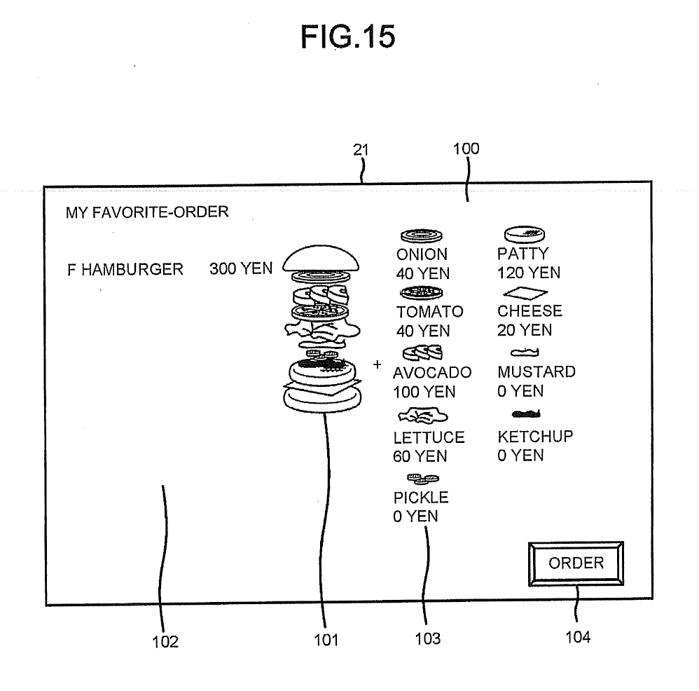

FIG. 14 is a flow chart illustrating an example of the flow of the my favorite-order reception processing, and FIG. 15 to FIG. 17 are examples of the screen display of the display unit 21 of the electronic menu terminal 1 in the my favorite-order reception processing. An example of the my favorite-order reception processing is described with reference to the flow chart in FIG. 14 and examples of the screen display in FIG. 15 to FIG. 17.

When it is determined that the my favorite-order is instructed (Yes in ACT S11), the CPU 11 first retrieves the article image file 33, using each part ID in the article information specified by the pointer and reads out the image data stored in association with each part ID (ACT S31). Afterwards, the CPU 11 generates a my favorite-order screen 100 based on the article decomposition image obtained by combining these image data, and the article information written in the order information record as a new order information, and the my favorite-order screen 100 is displayed on the display unit 21 (ACT S32: the article decomposition image display element).

An example of the my favorite-order screen 100 is shown in FIG. 15. As shown in FIG. 15, the image respectively corresponding to each part ID of the menu article “hamburger F” in the order information record is displayed in an article decomposition image display area 101 of the my favorite-order screen 100. In more detail, preset food materials, such as, e.g., onion, avocado, tomato, lettuce, mustard, pickle, patty and cheese are displayed with the preset weights to a bun the size of which is preset to the menu article “hamburger F”. In addition, in such a display, each of the food materials sandwiched in the bun described above may be vibrated, respectively.

As shown in FIG. 15, the article name and the article unit price of the menu article “hamburger F” in the order information record are displayed in a detail display area 102 of the my favorite-order screen 100 as an order details.

In addition, as shown in FIG. 15, in an addition/change food material display area 103 of the my favorite-order screen 100, images of the food material which are able to be added or changed to each part of the menu article “hamburger F” in the order information record are displayed.

As also shown in FIG. 15, an order button 104 is displayed on the my favorite-order screen 100 as a function button.

The CPU 11 which displays the my favorite-order screen 100 on the display unit 21 waits until addition/change of the food materials on the my favorite-order screen 100 by a customer is input (ACT S33) or the order is input (ACT S34). If instruction for the addition/change of the food materials on the my favorite-order screen 100 by a customer is detected with the signal from the touch panel sensor 22 (Yes in ACT S33), the CPU 11 executes the order reception processing in response to the instruction (ACT S34).

In the order reception processing, for example, when the customer removes a part or one of the food materials displayed from the article decomposition image display area 101 of the my favorite-order screen 100 (cancel instruction), a cancel processing is carried out to the removed food material in the order information record, and a renewed my favorite-order screen 100 is generated to display the renewed my favorite-order screen 100 on the display unit 21 in response to the cancel instruction.

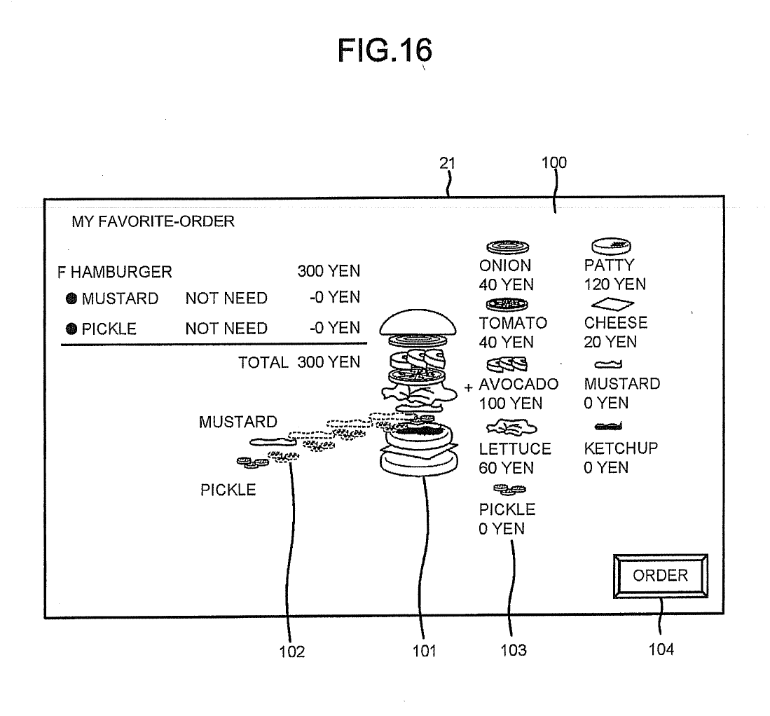

An example of the my favorite-order screen 100 responding to the instruction is shown in FIG. 16. As shown in FIG. 16, the images (referring to FIG. 4) specified by the image data of the instructed food materials (mustard and pickle in FIG. 16) are extracted from the image database 2C to be displayed on the article decomposition image display area 101 on the my favorite-order screen 100, and moves towards the removing direction. Afterwards, the instructed food materials (mustard and pickle in FIG. 16) finally disappear from the food materials sandwiched in the bun.

As shown in FIG. 16, the order detail of the detail display area 102 of the my favorite-order screen 100 is also renewed based on the order information record that the removed food materials are canceled in the cancel processing.

Other example of the order reception processing is described. For example, when the customer carries out an operation of adding any of the food materials displayed on the addition/change food material display area 103 of the my favorite-order screen 100 to the specified position of the article decomposition image display area 101, the addition processing for the added food materials is carried out to the order information record, and a my favorite-order screen 100 responding to the instruction is generated to display the my favorite-order screen 100 on the display unit 21.

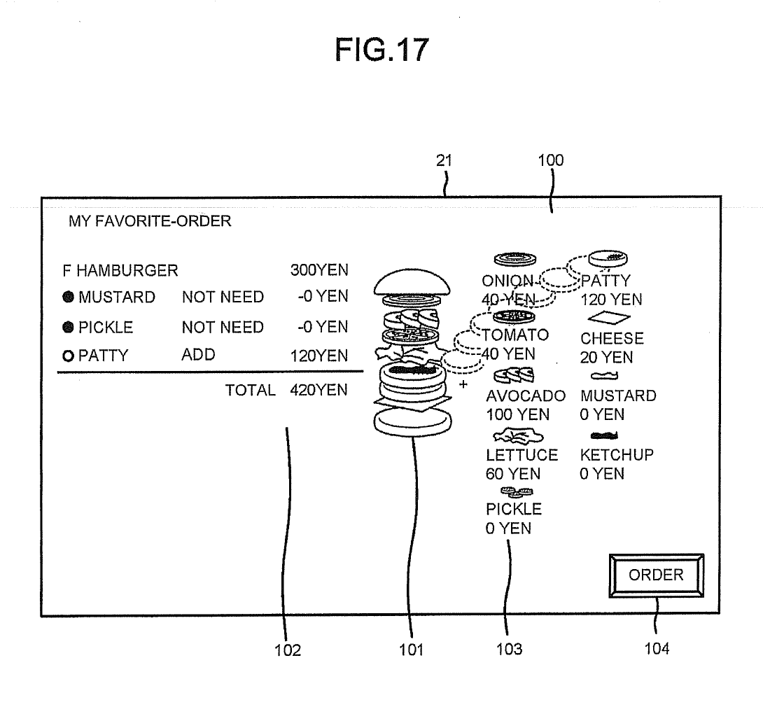

Still other example of the my favorite-order screen 100 responding to the instruction is shown in FIG. 17. As shown in FIG. 17, in the my favorite-order screen 100, the image (referring to FIG. 4) specified by the image data of the instructed food material (patty in FIG. 17) is extracted from the image database 2C. Afterwards, the image of the food material (patty in FIG. 17) instructed in the image of the article decomposition image display area 101 is inserted into the instructed position in the article decomposition image display area 101, and such an image is displayed as if “patty” is added to the “hamburger F” in the article decomposition image display area 101.

In addition, as shown in FIG. 17, the order detail in the detail display area 102 of the my favorite-order screen 100 is also renewed based on the order information record that the food material is added in the addition processing. In the detail display area 102 of the my favorite-order screen 100, a color of the added food material may be different from that of the canceled food material.

In addition, not particularly shown in figures, for example, when the customer carries out an operation of moving a part or one of the food materials displayed on the article decomposition image display area 101 of the my favorite-order screen 100 to other position, the my favorite-order screen 100 displaying the commodity article image in which the image of the operated food material is moved to the instructed position is generated to display the generated my favorite-order screen 100 on the display unit 21 (ACT S32). Thus, the order of the food materials can be also altered.

In the order reception processing, when the addition or the cancellation to the order information record responding to the instruction of the addition or the cancellation to the food materials of the article item on the my favorite-order screen 100 by the customer is carried out, the price of the article item (A for example) as a result of the addition or cancellation instructed described above is compared with the price of other article item having the same food materials as the result of the addition or cancellation to the food materials of the article item A to select a cheaper one. For example, a case that food materials E and F are added to the menu article “hamburger D” which includes food materials A, C and D is described. In such a case, it is a common practice that the above described added food materials are subject to the addition processing to the order information record. However, if the menu article “hamburger E” including the food materials A, B, C, D, E and F is already offered, an article in which the food material B is removed from the menu article “hamburger E” is the same as the article in which food materials E and F are added to the menu article “hamburger D”. In this case, if each sum of the unit price of each food material of the two cases is the same as one another, a problem does not occur, but if it is different from one another, the CPU 11 executes the addition or the cancellation to the order information record based on the addition or the cancellation of the food material to the menu article whose price (sum of the unit price of each food material) is cheaper than that of another article.

In the flow chart in FIG. 14, when the touch operation to the order button 104 is detected with the signal from the touch panel sensor 22, the order is instructed (Yes in ACT S34), and therefore, the CPU 11 ends the my favorite-order reception processing and carries out ACT S13 in FIG. 7.

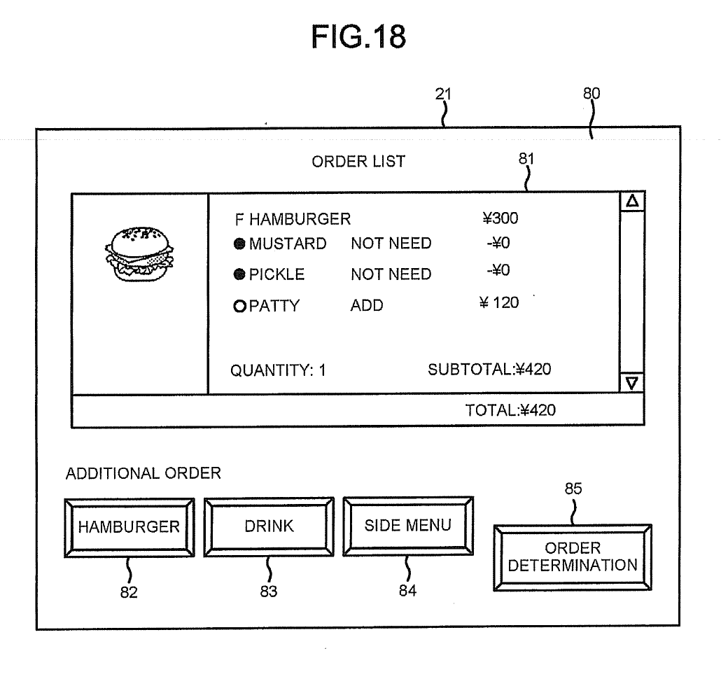

An example of the order list screen 80 executing on which the my favorite-order reception processing is executed is shown in FIG. 18. As shown in FIG. 18, the order list 81 indicating the content of data of the order information record based on the addition or alteration of food material to the menu article is displayed on the order list screen 80.

According to the electronic menu terminal 1 according of the present embodiment, if an action which is regarded as a cancel operation to a part of the article decomposition image constituting the article item on the display which is ordered is detected by the touch input section, the part subject to the cancel operation and the unit price thereof are canceled from the information relating to the order of the article item stored in the order information storage area and if an action which is regarded as an addition operation of a specific part to the article decomposition image displayed on the display is detected by the touch input section, the part subject to the addition operation and the unit price thereof are added to the information relating to the order of the article item stored in the order information storage area. Thus, the following effects are achieved that the order from a customer can be received while the content of order in which the variety of part (food material) constituting the article item ordered and the amount of the part are altered is directly showed to the customer to understand visually.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An order reception apparatus, comprising:
a display section configured to display an image;
a touch input section configured to detect the presence of touching and the movement of a point of the touching on an image displayed on the display section as an input;
an article information file, including a part which is set as an element of an article item or a part which is set as an element capable of being added to the article item, and a unit price corresponding to the part, which is configured to store an article information relating to the order of an article item for each article item;
an article image file configured to store the image of the part which is set for each article item in the article information file;
an order reception section configured to receive the order of an article item;
an order information storage section configured to read out information according to the order of an article item order of which is received by the order reception section from the article information file and store the information in a specified order information storage area;
an article decomposition image display section configured to display on the display section an article decomposition image formed with the combination of images of the parts, set as an element of the article item order of which is received by the order reception section, which are read out from the commodity image file; and
a change processing section configured to cancel the part subject to a cancel operation and the unit price of the part from information relating to the order of the article item stored in the order information storage area if the touch input section detects an action regarded as the cancel action to any one of the parts in the article decomposition image displayed on the display section, and add a part subject to an addition operation and the unit price of the part to information relating to the order of the article item stored in the order information storage area if the touch input section detects an action regarded as the addition operation to a specified part in the article decomposition image displayed on the display section.

2. The order reception apparatus according to claim 1, wherein
the change processing section compares the price of the article item resulting from the addition or cancel operation with the price of other article item having the same food materials as the result of the addition or cancellation to the food materials of the article item to select a cheaper one and executes the addition or the cancelation of the information relating to the order of the article item based on the addition or the cancellation of the part to the article item whose price is cheap when the addition or cancellation of the information relating to the order of the article item stored in the order information storage area is carried out.

3. The order reception apparatus according to claim 1, wherein
the article decomposition image display section displays on the display section an article decomposition image in which the image of an instructed part is cancelled if the touch input unit detects an action regarded as the cancel operation to any one of the parts of the article decomposition image displayed on the display section.

4. The order reception apparatus according to claim 1, wherein
the article decomposition image display section displays on the display section an article decomposition image in which the image of an instructed part is inserted at an instructed position if the touch input unit detects an action regarded as the addition operation of the specified part to the article decomposition image displayed on the display section.

5. The order reception apparatus according to claim 1, wherein
the article decomposition image display section displays on the display section an article decomposition image in which the image of an instructed part is moved to an instructed position if the touch input section detects an action regarded as a movement operation to any one of the parts of the article decomposition image displayed on the display section.
